(19) United States
(12) Patent Application Publication
(10) Pub. No.: US 2008/0291177 A1
(43) Pub. Date: Nov. 27, 2008

(54) TOUCH CONTROLLED DISPLAY DEVICE

(75) Inventors: KUN-SHENG KUO, Chu-Nan (TW); YUAN-FA CHU, Chu-Nan (TW)

Correspondence Address: PCE INDUSTRY, INC.;ATT. CHENG-JU CHIANG, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 11/967,074

(22) Filed: Dec. 29, 2007

(30) Foreign Application Priority Data
May 25, 2007 (CN) 200710074585.1

(51) Int. Cl. G06F 3/042

(52) U.S. Cl. 345/175

(57) ABSTRACT

An exemplary touch controlled display device includes is provided. The touch controlled display device includes a touch screen, a light emitting diode (LED) array substrate, and a control unit electronically connected with the touch screen and the LED array substrate. The touch screen is configured for allowing a user to touch thereon to generate a touch point and generating an input signal associated with the location of the touch point. The LED array substrate includes a number of LED units and each of the LED units corresponds to a pixel element of the touch controlled display device. The control unit is configured for receiving the input signal from the touch screen, obtaining the location coordinates of the touch point and generating a command signal to control the on/off states of the one or more LED units corresponding to the touch point.

### BACKGROUND

1. Technical Field

The present invention generally relates to display devices and, particularly, to a touch controlled display device.

2. Description of Related Art

With the rapid developments of science and technology, electronic devices, such as notebook computer, personal digital assistant (PDA), mobile phone, global positioning system (GPS) and multimedia player, are now in widespread use. A typical electronic information device is equipped with a number of mechanical keys, and a display device for displaying information such as characters, pictures, etc. The mechanical keys are used for inputting information to the electronic information device. However, with electronic device becoming smaller, the mechanical keys correspondingly are becoming smaller and thus inconvenient for the user to use.

Therefore, what is needed is a touch controlled display device, which would greatly facilitate the input of information for display.

### SUMMARY

A touch controlled display device, in accordance with a present embodiment, is provided. The touch controlled display device includes a touch screen, a light emitting diode (LED) array substrate, and a control unit electrically/electronically connected with the touch screen and the LED array substrate. The touch screen is configured (i.e., structured and arranged) for allowing a user to touch thereon to generate a touch point and generating an input signal associated with the location of the touch point. The LED array substrate includes a number of LED units and each of the LED units corresponds to a pixel element of the touch controlled display device. The control unit is configured for receiving the input signal from the touch screen, obtaining the location coordinates of the touch point and generating a command signal to control the on/off states of the one or more LED units corresponding to the touch point.

Due to the fact that the touch controlled display device is equipped with the touch screen, the control unit and the LED unit constituted pixels, information can be inputted by directly touching the touch screen. Accordingly, the present touch controlled display device can greatly facilitate the input of information for display.

Other advantages and novel features will become more apparent from the following detailed description of embodiments, when taken in conjunction with the accompanying drawings.

### BRIEF DESCRIPTION OF THE DRAWINGS

Many aspects of the present touch controlled display device can be better understood with reference to the following drawings. The components in the drawings are not necessarily drawn to scale, the emphasis instead being placed upon clearly illustrating the principles of the present touch controlled display device. Moreover, in the drawings, like reference numerals designate corresponding parts throughout the several views.

FIG. 1 is a schematic, cross-sectional view of a touch controlled display device, in accordance with a first embodiment.

FIG. 2 is a principal structural view of a touch screen of the touch controlled display device of FIG. 1.

FIG. 3 is an operational state view of the touch screen of FIG. 2.

FIG. 4 is a principal structural view of a touch screen, in accordance with a second embodiment.

FIG. 5 is a schematic, cross-sectional view of the touch screen of FIG. 4.

FIG. 6 is a principal structural view of a touch screen, in accordance with a third embodiment.

FIG. 7 is a principal structural view of a touch screen, in accordance with a fourth embodiment.

FIG. 8 is a principal structural view of a touch screen, in accordance with a fifth embodiment.

The exemplifications set out herein illustrate various preferred embodiments, in various forms, and such exemplifications are not to be construed as limiting the scope of the present touch controlled display device in any manner.

### DETAILED DESCRIPTION

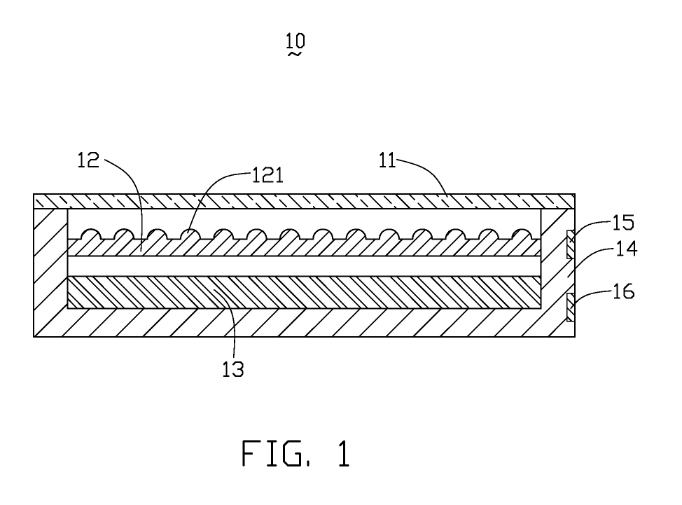

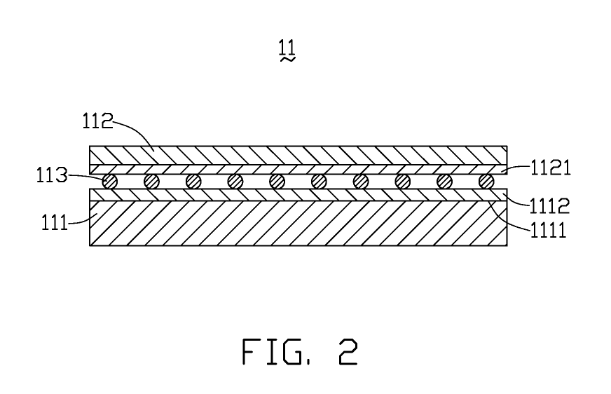

FIGS. 1 and 2 show a first embodiment of the present invention, a touch controlled display device 10, in accordance with the first embodiment, is provided. The touch controlled display device 10 includes: a touch screen 11, a light emitting diode (LED) array substrate 12, a control unit 13 and a housing 14.

The touch screen 11 (generally also referred to as touch panel) is configured (i.e., structured and arranged) for allowing a user to touch thereon so as to generate a touch point and generating an input signal associated with the location of the touch point. In particular, as illustrated in FIG. 2, the touch screen 11 includes a glass substrate 111, a transparent plastic layer 112 disposed on the glass substrate 111 and a number of dot spacers 113 disposed between the glass substrate 111 and the transparent plastic layer 112. A first indium-tin oxide (ITO) conductive layer 1112 is formed on a top surface of the glass substrate 111. A second ITO conductive layer 1121 is formed on a bottom surface of the transparent plastic layer 112. The first and the second ITO conductive layers 1112, 1121 are separated from each other by the dot spacers 113. Preferably, the transparent plastic layer 112 can be treated by hardening process to improve its wear resistance.

The LED array substrate 12 includes a number of LED units 121 arranged in rows and columns. Each of the LED units 121 corresponds to a pixel element of the touch controlled display device 10 and contains one or more LED chips. Generally, the LED array substrate 12 further includes a printed circuit board and a driver module (not shown). The driver module is mounted on the printed circuit board and configured for driving the LED units 121. The LED units 121 are mounted on the printed circuit board and electrically connected with the driver module.

The control unit 13 is configured for receiving the input signal from the touch screen 11, obtaining the location coordinates of the touch point and generating a command signal to control the on/off states of the one or more LED units 121 corresponding to the touch point, for information display. The LED units 121 of the LED array substrate 12 are subjected to the control of the command signal. The control unit 13 is electrically connected with the touch screen 11 and the LED array substrate 12. The control unit 13 beneficially can be a microprocessor control unit (MCU), a complex programmable logic device (CPLD), or a field programmable gate array (FPGA).

The housing 14 allows the LED array substrate 12 and the control unit 13 to be housed therein. The touch screen 11 is disposed on the front of the LED array substrate 12 and mounted on the housing 14.

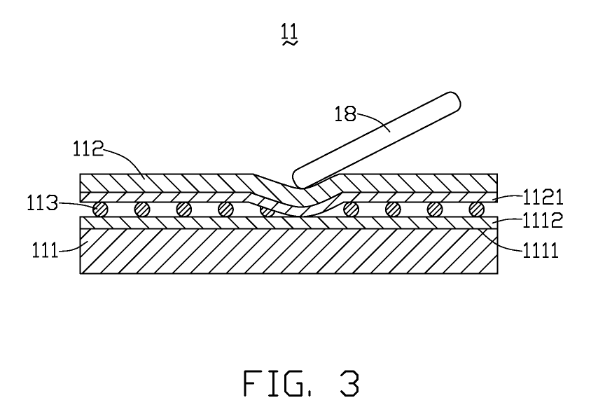

As illustrated in FIG. 3, a user can apply a touch action on the touch screen 11 using a stylus 18 or other object, such as a finger of the user. In operation, when the user touches the transparent plastic layer 112 of the touch screen 11 with an object, the transparent plastic layer 112 is locally bent toward the glass substrate 111 under a pressure resulting from the touch action. The ITO conductive layers 1112 and 1121 are locally brought into contact with each other so as to generate a touch point. The touch screen 11 will obtain a variable resistance value corresponding to the location of the touch point. Thereafter, the touch screen 11 generates an input signal associated with the location of the touch point, according to the obtained resistance value. As a result, expected information will be displayed on the touch controlled display device 10 by switching the on/off states of the corresponding LED units 121 of the LED array substrate 12.

In addition, in the case of each of the LED units 121 containing multiple (i.e., more than one) LED chips, the touch controlled display device 10 can be equipped with a first control switch 15 electrically connected with the LED chips of each LED units 121. The first control switch 15 is installed on the housing 14 and accessible from the outside of the housing 14 by the user. The first control switch 15 is configured for enabling one or more LED chips of each LED units 121 to emit light so that the color of the light emitted from the LED array substrate 12 is switchable. For illustration, the LED array substrate 12 can be switched to emit various colored light (e.g., red, green, blue, etc.) or a white light. Optionally, the touch controlled display device 10 is configured with a second control switch 16 electrically connected with the LED units 121 of the LED array substrate 12 so as to clear the information displayed thereon. The second control switch 16 is secured on the housing 14 and accessible from the outside of the housing 14 by the user.

Furthermore, the touch controlled display device 10 rather suitably incorporates a storage device (not shown) therein. The storage device is configured for storing displayed information and thereafter facilitating the transfer of the displayed information to other display terminal, such as computer monitor, television set or projector.

It should be noted that the touch controlled display device 10 is not limited to have the above-mentioned touch screen 11, the touch screens will be described in below embodiments, are acceptable as well.

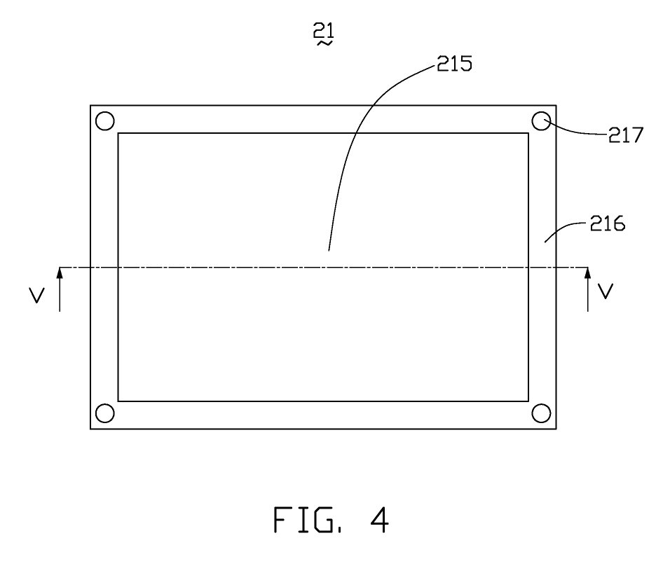

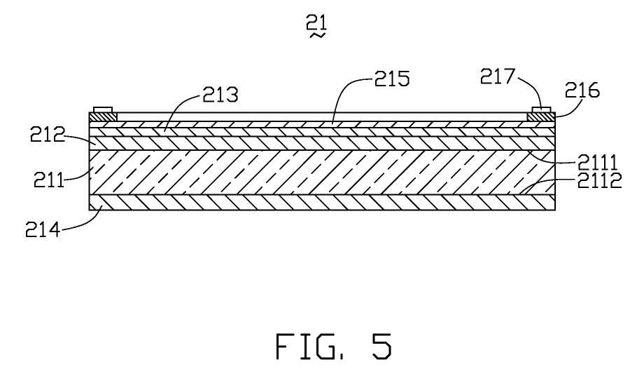

FIGS. 4 and 5 show a second embodiment of the present invention, a touch screen 21, in accordance with the second embodiment, is provided. The touch screen 21 includes a glass substrate 211, a pair of ITO conductive layers 212, 214, a transparent protection layer 213, a metal conductive thin film layer 215, a metal frame 216 and four electrodes 217. The glass substrate 211 may be quadrangular in shape. The glass substrate 211 has a top surface 2111 and an opposite bottom surface 2112. The ITO conductive layers 212, 214 are respectively disposed on the top surface 2111 and the bottom surface 2112. The transparent protection layer 213 is located on the ITO conductive layer 212 and may be a dielectric layer, such as silicon dioxide (SiO2) layer. The metal conductive thin film layer 215 is formed on the protection layer 213. The metal frame 216 has an approximately rectangular ring shape and is arranged on four sides of the metal conductive thin film layer 215. The four electrodes 217 are disposed on four corners of the metal frame 216. In other words, the four electrodes 217 are located at opposite ends of two diagonals of the metal frame 216.

In operation, when a high frequency electric signal is applied between the ITO conductive layers 212, 214 and the user touches the metal conductive thin film layer 212 with an electrically conductive touch object (e.g., a finger or a conductive stylus) to generate a touch point, a coupling capacitor would be formed. In particular, the coupling capacitor is constituted by the touch object, the ITO conductive layer 212 and the protection layer 213. Because the ITO conductive layer 212 is supplied with the high frequency electric signal, current will flow from each of the four electrodes 217 to the touch object through the metal conductive thin film layer 215. The touch screen 21 detects the current flowing from each of the four electrodes 217 and generates a corresponding input signal. The control unit 13 (see FIG. 1) will receive the input signal from the touch screen 21, and obtains the location coordinates of the touch point based upon the principle that the current flowing from each of the four electrodes 217 is proportional to the distance between the touch object and the corresponding one electrode 217. Thereafter, the control unit 13 will generate a corresponding command signal according to the calculated location coordinates and transmit it to the LED array substrate 12 for controlling the on/off states of the one or more LED units 121 corresponding to the touch point.

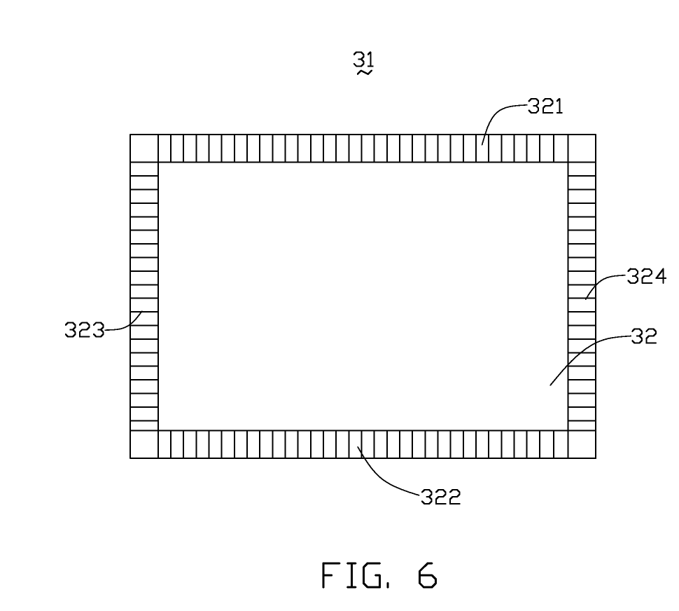

FIG. 6 shows a third embodiment of the present invention, a touch screen 31, in accordance with the third embodiment, is provided. The touch screen 31 includes a transparent base 32, a number of first direction infrared (IR) emitters 321, a number of first direction IR detectors 322, a number of second direction IR emitters 323 and a number of second direction IR detectors 324. The transparent base 32 may be quadrangular in shape. The transparent base 32 may be made of glass, or other transparent/translucent material. The first direction IR emitters 321 and the first direction IR detectors 322 are disposed on opposite sides of a top surface of the transparent base 32 and constitute a number of paired first direction IR emitter-detectors. The second direction IR emitters 323 and the second direction IR detectors 324 are disposed on another opposite sides of the top surface of the transparent base 32 and constitute a number of paired second direction IR emitter-detectors.

In operation, the IR light emitted from the first direction and second direction IR emitters 321, 323 will constitute an IR light network. When the user touches the transparent base 32 with a touch object (e.g., a finger or a stylus) to generate a touch point, the touch object will block the IR light emitted from at least one of the first direction IR emitters 321 and at least one of the second direction IR emitters 323. The corresponding first direction IR detector 322 and second direction IR detector 324 will detect the blocking of the IR light. Thereafter, the touch screen 31 will generate an input signal associated with the location of the touch point, according to the detection results of the corresponding first direction IR detector 322 and the second direction IR detector 324. The control unit 13 (see FIG. 1) receives the input signal from the touch screen 31, obtains the location coordinates of the touch point and generates a corresponding command signal. The command signal will be transmitted to the LED array substrate 13 for controlling the on/off states of the one or more LED units 121 corresponding to the touch point.

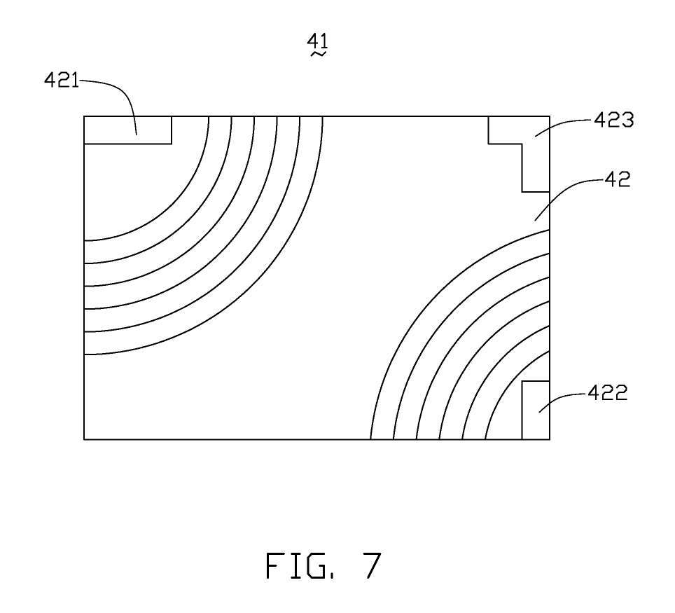

FIG. 7 shows a fourth embodiment of the present invention, a touch screen 41, in accordance with the fourth embodiment, is provided. The touch screen 41 includes a transparent base 42, a first direction ultrasonic emitter 421, a second direction ultrasonic emitter 422 and an ultrasonic receiver 423. The first direction and second direction ultrasonic emitters 421, 422 are disposed at opposite corners of the transparent base 42. The ultrasonic receiver 423 is disposed another corner of the transparent base 42 so that the first direction ultrasonic emitter 421, the second direction ultrasonic emitter 422 and the ultrasonic receiver 423 are arranged in a triangular manner. The transparent base 42 may be quadrangular in shape. The transparent base 42 may be made of glass, or other transparent/translucent material.

In operation, the ultrasonic waves (as denoted by the arc-shaped lines in FIG. 7) generated from the first direction and second direction ultrasonic emitters 421, 422 and propagated along two different directions will distribute over the top surface of the transparent base 42. When the user touches the transparent base 42 with a touch object to generate a touch point, the touch object will locally absorb the energy of the ultrasonic waves. In this situation, the ultrasonic waves will be attenuated at the location of the touch point and whereby attenuation gaps are formed. That is, the waveforms of the ultrasonic waves changes. The ultrasonic receiver 423 will receive the ultrasonic waves with the attenuation gaps and generate a corresponding input signal. The control unit 13 (see FIG. 1) will receive the input signal from the ultrasonic receiver 423 of the touch screen 41, obtains the location coordinates of the touch point according to the waveforms of the ultrasonic waves using a simple triangulation technique, and generates a corresponding command signal. The command signal will be transmitted to the LED array substrate 13 for controlling the on/off states of the one or more LED units 121 corresponding to the touch point.

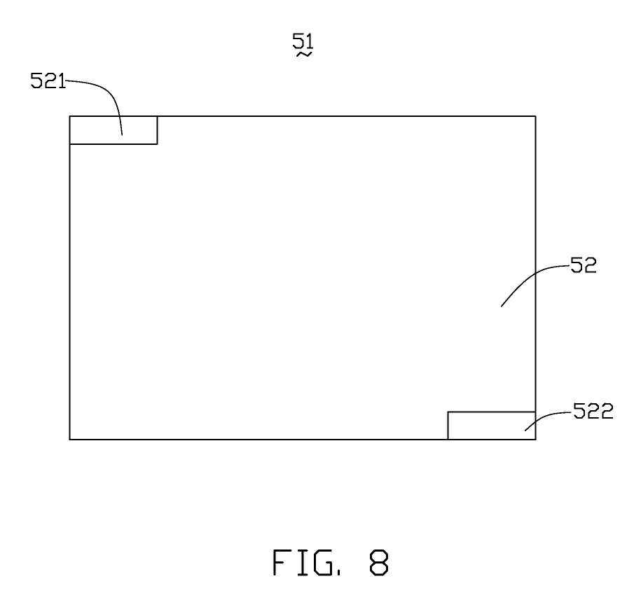

Referring to FIG. 8, a touch screen 51, in accordance with a fifth embodiment, is provided. The touch screen 51 includes a transparent base 52 and multiple imaging units, e.g., imaging units 521, 522 disposed on a top surface of the transparent base 52. The imaging units 521, 522 are diagonally arranged at two opposite corners of the top surface of the transparent base 52. The transparent base 52 may be quadrangular in shape. The transparent base 52 may be made of glass, or other transparent/translucent material. Each of the imaging units 521, 522 includes an image sensor, an analog-to-digital converter and a digital signal processor (DSP). The image sensor may be a charge coupled device (CCD) sensor or a complementary metal-oxide-semiconductor (CMOS) sensor.

In operation, when the user touches the transparent base 52 with a touch object to generate a touch point, a local disturbance or distortion of the top surface of the transparent base 52 occurs. The image sensors of the imaging units 521, 522 will capture images of the top surface including the local disturbance or distortion, from two different views. The captured images are transmitted to the respective analog-to-digital converters and digital signal processors of the imaging units 521, 522 for further processing. The imaging units 521, 522 each will output an input signal associated with the location of the touch point to the control unit 13 (see FIG. 1). The control unit 13 obtains the location coordinates of the touch point by processing the two input signals and generates a corresponding command signal. The command signal will be transmitted to the LED array substrate 13 for controlling the on/off states of the one or more LED units 121 corresponding to the touch point.

It is believed that the present embodiments and their advantages will be understood from the foregoing description and it will be apparent that various changes may be made thereto without departing from the spirit and scope of the invention or sacrificing all of its material advantages, the examples hereinbefore described merely being preferred or exemplary embodiments of the present invention.

What is claimed is:

1. A touch controlled display device, comprising:
a touch screen configured for allowing a user to touch thereon to generate a touch point and generating an input signal associated with the location of the touch point;
a light emitting diode array substrate comprising a plurality of light emitting diode units, each of the light emitting diode units corresponding to a pixel element of the touch controlled display device; and
a control unit electronically connected with the touch screen and the light emitting diode array substrate, the control unit being configured for receiving the input signal from the touch screen, obtaining the location coordinates of the touch point and generating a command signal to control the on/off states of the one or more light emitting diode units corresponding to the touch point.

2. The touch controlled display device of claim 1, further comprising a housing, the light emitting diode array substrate and the control unit housed in the housing, the touch screen disposed on the front of the light emitting diode array substrate and mounted on the housing.

3. The touch controlled display device of claim 2, further comprising a first control switch, each of the light emitting diode units containing multiple light emitting diode chips, the first control switch installed on the housing and accessible from the outside of the housing by the user, the first control switch configured for enabling one or more light emitting diode chips of each light emitting diode units to emit light so that the color of the light emitted from the light emitting diode array substrate is switchable.

4. The touch controlled display device of claim 2, further comprising a second control switch secured on the housing, the second control switch accessible from the outside of the housing by the user and configured for clearing information displayed on the touch controlled display device.

5. The touch controlled display device of claim 1, further comprising a stylus configured for applying a touch action on the touch screen to generate the touch point by the user.

6. The touch controlled display device of claim 1, wherein the touch screen comprises:
a glass substrate having a first indium-tin oxide conductive layer formed on a top surface thereof;
a transparent plastic layer disposed on the glass substrate, the transparent plastic layer having a second indium-tin oxide conductive layer formed on a bottom surface thereof which faces toward the top surface of the glass substrate; and
a plurality of dot spacers disposed between the glass substrate and the transparent plastic layer, the first and the second indium-tin oxide conductive layers being separated from each other by the dot spacers.

7. The touch controlled display device of claim 1, wherein the touch screen comprises:
a glass substrate having a top surface and an opposite bottom surface;
a pair of indium-tin conductive layers respectively formed on the top surface and the bottom surface;
a transparent protection layer disposed on the indium-tin conductive layer which is formed on the top surface;
a metal conductive thin film layer formed on the transparent protection layer;
a metal frame arranged on four sides of the metal conductive thin film; and
four electrodes disposed on four corners of the metal frame.

8. The touch controlled display device of claim 1, wherein the touch screen comprises:
a transparent base having a top surface;
a plurality of first direction infrared emitters and a plurality of first direction infrared detectors, the first direction infrared emitters and the first direction infrared detectors being disposed on opposite sides of the top surface and constituting a plurality of paired first direction infrared emitter-detectors; and
a plurality of second direction infrared emitters and a plurality of second direction infrared detectors, the second direction infrared emitters and the second direction infrared detectors being disposed on another opposite sides of the top surface and constituting a plurality of paired second direction infrared emitter-detectors.

9. The touch controlled display device of claim 1, wherein the touch screen comprises:
a transparent base having a top surface;
a first direction ultrasonic emitter and a second direction ultrasonic emitter disposed on opposite corners of the transparent base and configured for emitting ultrasonic waves propagated along two different directions to distribute over the top surface; and
a ultrasonic emitter disposed on another corner of the transparent base and configured for receiving the ultrasonic waves.

10. The touch controlled display device of claim 1, wherein the touch screen comprises:
a transparent base having a top surface; and
a plurality of imaging unit diagonally arranged on two opposite corners of the top surface, the imaging units configured for capturing images of the top surface including the local disturbance or distortion resulting from the touch action and generating the input signal associated with the location of the touch point.
